(19) United States
(12) Patent Application Publication
(10) Pub. No.: US 2009/0019244 A1
(43) Pub. Date: Jan. 15, 2009

(54) Information Record/Read Apparatus

(76) Inventor: Keiichi Maeda, Tokyo (JP)

Correspondence Address: BIRCH STEWART KOLASCH & BIRCH, PO BOX 747, FALLS CHURCH, VA, 22040-0747, US

(21) Appl. No.: 10/576,077

(22) PCT Filed: Jun. 9, 2005
(86) PCT No.: PCT/JP05/10608

§ 371 Date: Apr. 14, 2006

(30) Foreign Application Priority Data
Sep. 17, 2004 (JP) 2004-271918

(51) Int. Cl. G06F 12/02

(52) U.S. Cl. 711/159; 711/E12.002

(57) ABSTRACT

A plurality of sectors 1a, which constitute a flash memory 1, are each divided into a plurality of blocks 1b. Each of the plurality of blocks 1b has a data recording area 1c, and a block state management area 1d for recording data indicating whether data is unrecorded, is recording, or has been recorded in the data recording area 1c. The “recorded” or “recording” makes it possible to easily decide as to whether the record data is reliable, thereby improving the accuracy of the data recording. Dividing the sector to the plurality of blocks 1b can increase the number of times of data rewritings per sector 1a by a factor of N as compared with a conventional system, and reduce the number of times of erasures to 1/N, thereby being able to extend the life of the flash memory 1.

### TECHNICAL FIELD

The present invention relates to an information record/read apparatus for carrying out recording, reading and erasing of the data of an involatile memory typified by a flash memory.

### BACKGROUND ART

An involatile memory typified by a flash memory has an advantage that it can hold its recorded contents even after turning off the power supply. Applying this advantage enables a using method of recording the set state just before the power-down, holding the recording contents after the power-down, and acquiring and setting the set state at the power-down at the restart of the power. Recently, a variety of types of electronic information apparatuses such as a DVD (Digital Versatile Disc) player adopt such a using method. The flash memory has a plurality of sectors that constitute part of a data recording area and serve as a unit of data erasure. In addition, although the flash memory must reset a bit that is set at “1” to “0” on a bit by bit basis, it must set a bit that is placed at “0” to “1” on a sector by sector basis (called “sector erasure).

Conventionally, to update the data recorded in a sector, a step is taken of erasing the data written in the sector, followed by writing update data into the same sector. The method, however, has a problem of losing the entire data if the power is turned off during the data erasure or data write of the sector.

As conventional information record/read apparatuses dealing with the problem, the following examples are known.

The foregoing conventional example relates to an information record/read apparatus using a block erasure-type flash memory which prevents the data write from being biased to a particular memory block, and aims at preventing data loss at a processing interruption of the data write. In the block erasure-type flash memory, each of a plurality of memory blocks has a data write area and a management status write area. In the management status write area, are written a write data identifying data ID, an erasure counter that represents the number of times of erasures of the data write memory block, and a write status indicating a time-series order of the data written in the same data ID. When a processor writes new data, it erases the memory block with which the write status indicates a write enabled state and the erasure counter indicates a minimum. After that, the processor writes new data and management status, and updates the management status including the same data ID in other memory blocks (see, Relevant Document 1).

Relevant Document 1: Japanese patent application laid-open No. 2001-312891.

With the foregoing configuration, the conventional information record/read apparatus updates the write status at a final stage of a series of data recording (write) steps. Accordingly, it has a problem in that if the power supply is shut down during the data recording processing, even if the data remains, the apparatus cannot make a decision as to whether the data is at the power down or the data recorded just previously.

In addition, the data erasure of the sector takes a much more time than the data recording. Consequently, the conventional method including the conventional example that performs the erasure at the data rewrite has a problem of being unable to carry out the data rewrite normally. This is because the configuration of the conventional method, which performs the data recording by detecting the voltage drop due to the shutdown of the power supply, has a difficulty of maintaining the power during the data erasure and data recording of the sector.

On the other hand, the involatile memory typified by a flash memory has an upper limit of the number of times of the data erasures per sector, thereby having a limit (life) of the use. Accordingly, it is necessary for the information record/read apparatus utilizing such an involatile memory with the using limit to have a means for extending the life.

The present invention is implemented to solve the foregoing problems. Therefore it is an object of the present invention to provide an information record/read apparatus that can improve the accuracy of the data recording, and has a means for extending the life.

### DISCLOSURE OF THE INVENTION

The information record/read apparatus in accordance with the present invention includes: an involatile memory including a plurality of blocks which are formed by dividing each of a plurality of sectors and each have a data recording area and a block state management area for indicating as to whether data is in an unrecorded, recording or recorded state in the data recording area, and a data recording state management area for indicating recording states of the data in all the plurality of sectors; and a control section for controlling, according to the record data in the data recording state management area of the involatile memory or to the record data in the block state management area and in the data recording state management area, the involatile memory in a manner that writes data cyclically into the data recording areas of the plurality of blocks of all the sectors, reads the record data, collectively erases the record data on a sector by sector basis, and updates the record data in the block state management area and data recording state management area.

According to the present invention, a configuration is made in such a manner that the involatile memory having the plurality of sectors includes the plurality of blocks which are formed by dividing each of the plurality of sectors and each have the data recording area and the block state management area for indicating as to whether the data is in the unrecorded, recording or recorded state in the data recording area, and the data recording state management area for indicating recording states of the data in all the plurality of sectors; and that the control section controls, according to the record data in the data recording state management area of the involatile memory or to the record data in the block state management area and in the data recording state management area, the involatile memory in a manner that writes data cyclically into the data recording areas of the plurality of blocks of all the sectors, reads the record data, collectively erases the record data on a sector by sector basis, and updates the record data in the block state management area and data recording state management area. This enables the control section to make a decision easily as to whether or not the data recorded in the block is reliable according to the “recorded” state the block state management area indicates, or to the “recording” state indicating that the data recording is interrupted before reaching the “recorded” state and hence the incomplete data, thereby being able to improve the accuracy of the data recording.

In addition, the control section restores the record data of the block indicating the “recording” state by utilizing the record data in the “recorded” state in the previous block, and recovers the data close to the latest state, thereby being able to improve the accuracy of the data recording.

Furthermore, the configuration, in which the sectors are each divided into the plurality of blocks, the data are recorded cyclically into the data recording areas of the plurality of blocks spreading all over the sectors, and the erasure of the record data is collectively performed on a sector by sector basis, can prolong the life of the flash memory. For example, when each sector is divided into N blocks, the number of times of data rewrites per sector is increased by a factor of N, and the number of times of erasures is reduced to (1/N) as compared with the conventional example. Thus, the life of the flash memory, which has a limit (life) in the number of times of data erasures per sector can be lengthened. In addition, since the data are recorded cyclically into the data recording areas of the plurality of blocks, the erasure of the record data is made uniform rather than concentrated to a particular sector as in the conventional example, thereby being able to contribute to extending the life of the flash memory, and to improve the reliability.

### BRIEF DESCRIPTION OF THE DRAWINGS

FIG. 1 is a diagram showing a configuration of an information record/read apparatus of an embodiment 1 in accordance with the present invention;

FIG. 2 is a table illustrating data to be recorded in a block state management area of FIG. 1 and states indicated by the data;

FIG. 3 is a flowchart illustrating a control processing of the data recording in the information record/read apparatus of the embodiment 1 in accordance with the present invention;

FIG. 4 is a flowchart illustrating a control processing of the data read in the information record/read apparatus of the embodiment 1 in accordance with the present invention;

FIG. 5 is a flowchart illustrating a control processing of the data erasure in the information record/read apparatus of the embodiment 1 in accordance with the present invention;

FIG. 6 is a flowchart illustrating the S_RD calculation processing in FIG. 5;

FIG. 7 is a flowchart illustrating a control processing of the data recording having a function of interrupting the data erasure processing in the information record/read apparatus of the embodiment 1 in accordance with the present invention;

FIG. 8 is a diagram showing a configuration of the information record/read apparatus of an embodiment 2 in accordance with the present invention;

FIG. 9 is a table illustrating data to be recorded in a preceding sector erasure state management area of FIG. 8 and states indicated by the data;

FIG. 10 is a flowchart illustrating a control processing of the data erasure in the information record/read apparatus of the embodiment 2 in accordance with the present invention;

FIG. 11 is a flowchart illustrating a processing for retrieving S_ER in FIG. 10;

FIG. 12 is a flowchart illustrating a calculation processing of a data write target block number (B_WR) and a data read target block number (B_RD) in the information record/read apparatus of the embodiment 2 in accordance with the present invention;

FIG. 13 is a flowchart illustrating the calculation processing of B_OLD in FIG. 12; and

FIG. 14 is a flowchart illustrating a control processing of the data recording having a function of interrupting the data erasure processing in the information record/read apparatus of the embodiment 2 in accordance with the present invention.

### BEST MODE FOR CARRYING OUT THE INVENTION

The best mode for carrying out the invention will now be described with reference to the accompanying drawings to explain the present invention in more detail.

### Embodiment 1

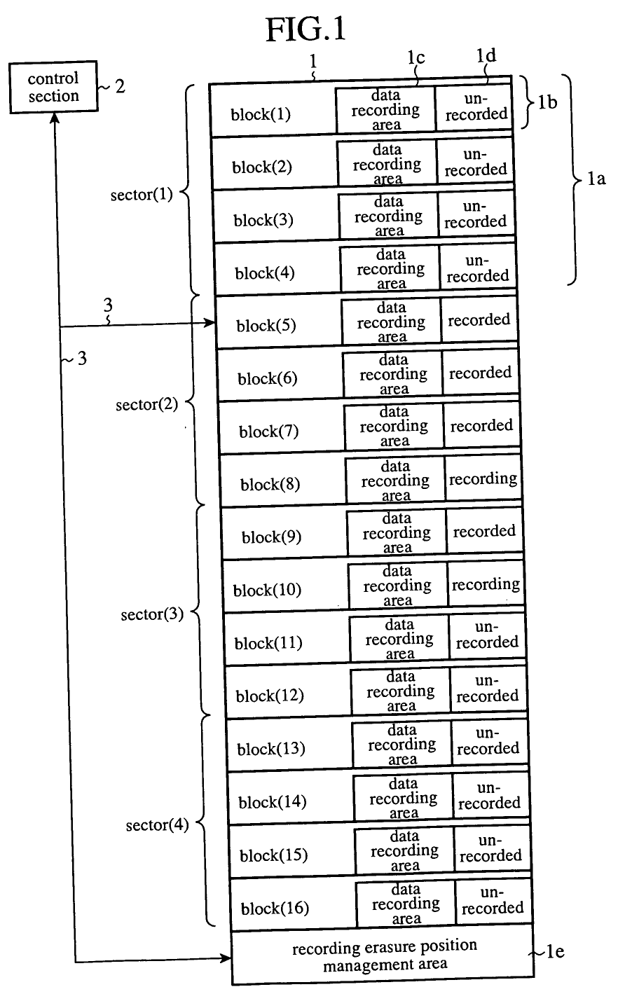

FIG. 1 is a diagram showing a configuration of an information record/read apparatus of an embodiment 1 in accordance with the present invention.

In FIG. 1, the information record/read apparatus, which employs a flash memory 1 as an involatile memory, has a configuration in which a control section 2 controls the flash memory 1 via an interface 3.

In the configuration, the flash memory 1, which constitutes part of a data recording area, has a plurality of sectors 1a that make a unit of data erasure. FIG. 1 is an example in which the sectors 1a include four sectors from a sector 1a(1) to a sector 1a(4). In addition, each of the sectors 1a from the sector 1a(1) to sector 1a(4) is divided into a plurality of blocks 1b that constitute a smaller data unit (capacity). FIG. 1 is an example in which each sector 1a is divided into four blocks so that the sectors 1a(1)-1a(4) include 16 blocks from the block 1b(1) to block 1b(16). Each of the blocks 1b(1)-1b(16) has a data recording area 1c and a block state management area 1d, and the data recording area 1c records (stores) information data. In this case, the data recording to the data recording areas 1c of the individual blocks 1b is carried out cyclically from the block 1b(1) to block 1b(16).

In addition, a block state management area 1d is a region for recording data indicating a data recording state of the block 1b including the block state management area 1d. The data recording area 1c of the block 1b records as to whether the data has not yet been recorded, is being recorded or has already been recorded.

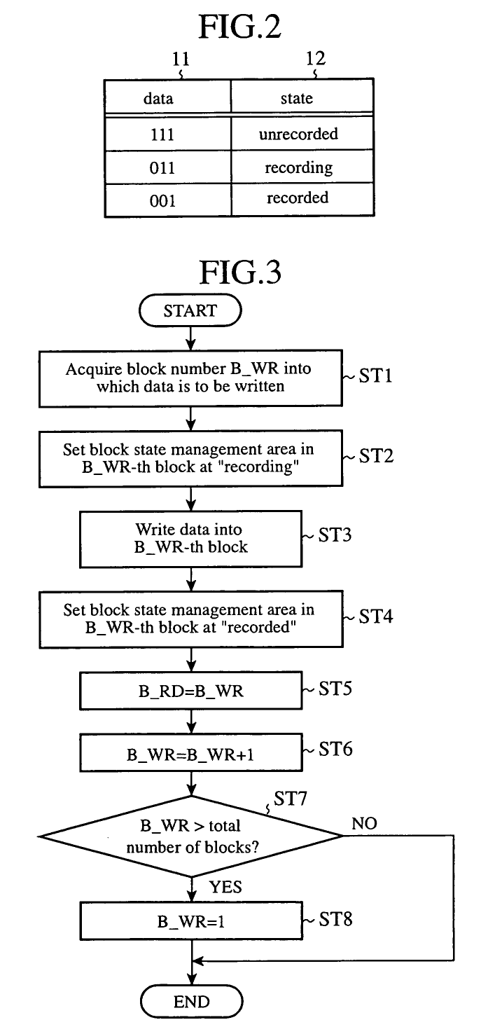

FIG. 2 is a table illustrating data to be recorded in the block state management area 1d and states indicated by the data.

In FIG. 2, the reference numeral 11 designates record data (contents) of the block state management area 1d, and 12 designates the states of the block 1b indicated by the record data.

The record data “111” indicates an “unrecorded” state, which means that no data is written in the data recording area 1c of the block 1b.

The record data “011” indicates a “recording” state, which means that data is being written into the data recording area 1c. The “recording” state indicates that the data recorded in the data recording area 1c is incomplete data.

The record data “001” indicates a “recorded” state, which means that the data writing to the data recording area 1c has been completed, and that the record data is normal.

In this case, since the rewriting of 1 to 0 can be performed on a bit-by-bit basis, the “unrecorded” can be changed to “recording” or “recorded”, and the “recording” can be changed to “recorded”.

On the other hand, to change the “recording” or “recorded” to “unrecorded”, the sector erasure must be performed.

In addition, apart from the four sectors 1a, a recording erasure position management area 1e is provided. It records data about the number (B_WR) of the block 1b into which data is written. Besides, it records data about the number (B_RD) of the block 1b which records the latest data and is the target of the data read, and data about the number (S_ER) of the sector 1a which has been used and becomes the target of the data erasure. To record the data about the numbers, a consideration is taken so as not to increase the number of times of recordings and erasures of the bits corresponding to a particular cell on the memory. In addition, the values corresponding to zero are recorded in advance as initial values of B_RD and S_ER.

The recording erasure position management area 1e constitutes a data recording state management area for recording data indicating the recording states of the data in all the four sectors 1a from the sector 1 to sector 4.

According to the record data in the recording erasure position management area 1e of the flash memory 1, the control section 2 identifies the position on the flash memory 1 at which the writing and reading of the data are made, and carries out the writing and reading control of the data to the specified position; identifies a data erasure target sector 1a, and carries out the data erasure and erasure interruption control of the specified sector 1a; and updates the record data of the block state management area 1d and of the recording erasure position management area 1e.

Furthermore, the control section 2 controls the flash memory 1 in such a manner as to write the data cyclically for all the data recording areas of all the sectors 1a from the block 1b(1) to block 1b(16).

In addition, the control section 2 carries out such processing as a variety of decisions and calculations concerning the foregoing control.

The control section 2 described above is composed of a CPU (central processing unit) and a memory, or a microcomputer or the like.

The interface 3 connects the flash memory 1 to the control section 2 in a controllable state.

Next, the data recording processing will be described with reference to FIG. 3.

FIG. 3 is a flowchart illustrating the control processing of the data recording into the flash memory 1 by the control section 2.

The processing will be described below of writing data into the data recording area 1c of the B_WR-th block 1b of the blocks 1b(1)-1b(16) of the flash memory 1 as shown in FIG. 1.

In FIG. 3, at step ST1, the control section 2 acquires the number B_WR of the block 1b into which the data is to be written from the recording erasure position management area 1e of the flash memory 1.

At step ST2, the control section 2 sets the record data in the block state management area 1d in the B_WR-th block 1b in the flash memory 1 at the “recording” state.

At step ST3, the control section 2 writes the data into the data recording area 1c of the B_WR-th block 1b.

Incidentally, as for the record data, since the control section 2 sets it to a set circuit (not shown) according to a setting input from a setting input means or the like (not shown), the control section 2 possesses the record data.

At step ST4, if the data recording has been completed, the control section 2 sets the record data in the block state management area 1d of the B_WR-th block 1b at the “recorded” state.

At step ST5, the control section 2 updates the data of the data read target block number (B_RD) of the recording erasure position management area 1e to the data on the number of the B_WR-th block (B_RD=B_WR-th) because the latest data has been written into the B_WR-th block 1b.

At step ST6, to advance the data recording position by one step to the next position, the control section 2 updates the number data of B_WR in the recording erasure position management area 1e to B_WR+1 (B_WR=B_WR+1).

At step ST7, the control section 2 makes a decision as to whether “B_WR=B_WR+1” updated at step ST6 exceeds the total number of the blocks 1b (16 blocks in this case). When it exceeds the total number of the blocks 1b (Yes at step ST7), the control section 2 advances the processing to step ST8, and if it does not exceed the total number of the blocks 1b (No at step ST7), the control section 2 completes the data recording processing.

At step ST8, the control section 2 modifies “B_WR=B_WR+1” updated at step ST6 to “B_WR=1” in order to designate the block 1b of the first sector (sector 1) cyclically, and completes the data recording processing.

The data recording processing is completed through the foregoing steps. In contrast with this, after setting the “recording” state at step ST2, if the data recording processing is terminated before reaching the “recorded” processing at step ST4 because of power-down or the like, the control section 2 maintains the record data in the block state management area 1d of the B_WR-th block 1b at “recording”. This shows that the data recorded in the B_WR-th block 1b is incomplete data. The handling of control section 2 in the case where the data recording processing is terminated in the “recording” state will be explained in the data read processing which will be described later.

As described above, the data recording is carried out with shifting the position of the recording blocks 1b step by step cyclically. Thus, the recording of the data can be performed by a block division number N (plural) per sector 1a. Accordingly, the number of times of the data rewrite per sector 1a can be increased by a factor of N. In addition, since the data recording state of the block 1b is written into the block state management area 1c, it is easy to learn as to whether the data recorded in the block 1b is reliable or not.

The foregoing is the description of the data recording processing.

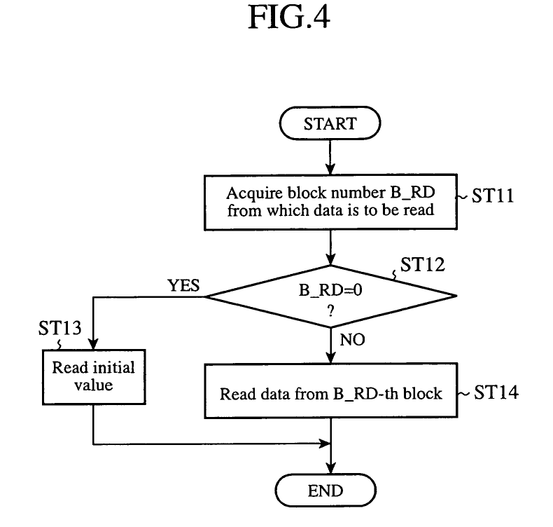

Next, the data read processing will be described with reference to FIG. 4.

FIG. 4 is a flowchart illustrating the control processing of the data read from the flash memory 1 by the control section 2.

The processing will be described of reading data from the B_RD-th block 1b in which the latest data is recorded among the blocks 1b(1)-1b(16) of the flash memory 1 as shown in FIG. 1.

In FIG. 4, at step ST11, the control section 2 acquires the number B_RD of the block 1b from which the data is read from the recording erasure position management area 1e of the flash memory 1.

At step ST12, the control section 2 makes a decision as to whether the block number B_RD acquired at step ST11 is zero (B_RD=0) or not. Then, it advances the processing to step ST13 if “B_RD=0” (Yes at step ST12), and to step ST14 unless “B_RD 0” (No at step ST12).

At step ST13, the control section 2 reads the initial value and terminates the data read processing.

The initial value is read when “B_RD=0” because no readable data is recorded in the flash memory 1. The initial value is recorded in the recording erasure position management area 1e of the flash memory 1 in advance.

At step ST14, the control section 2 reads the data from the B_RD-th block 1b and completes the data read processing.

If the record data of the block state management area 1d of the B_RD-th block 1b the control section 2 reads at step ST14 indicates the “recorded” state, the data in the B_RD-th block 1b is normal data. In contrast with this, if the record data of the block state management area 1d represents the “recording” state indicating that the data is incomplete data, such a configuration is also possible in which the control section 2 reads the record data of the block 1b one or more blocks previous to the B_RD-th block 1b, and according to the data, the control section 2 carries out recovery control to return the incomplete data of the B_RD-th block 1b to the data close to the latest state.

The foregoing is the data read processing.

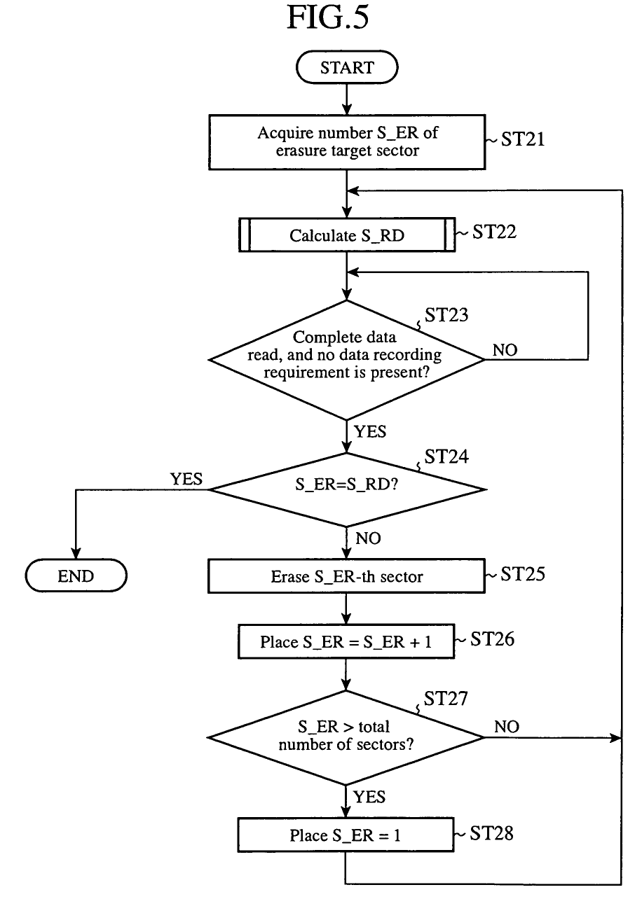

Next, the data erasure processing will be described with reference to FIG. 5.

FIG. 5 is a flowchart illustrating the control processing of the data erasure of the flash memory 1 by the control section 2.

In FIG. 5, at step ST21, the control section 2 acquires the number S_ER of the sector 1a which is the data erasure target from the recording erasure position management area 1e of the flash memory 1.

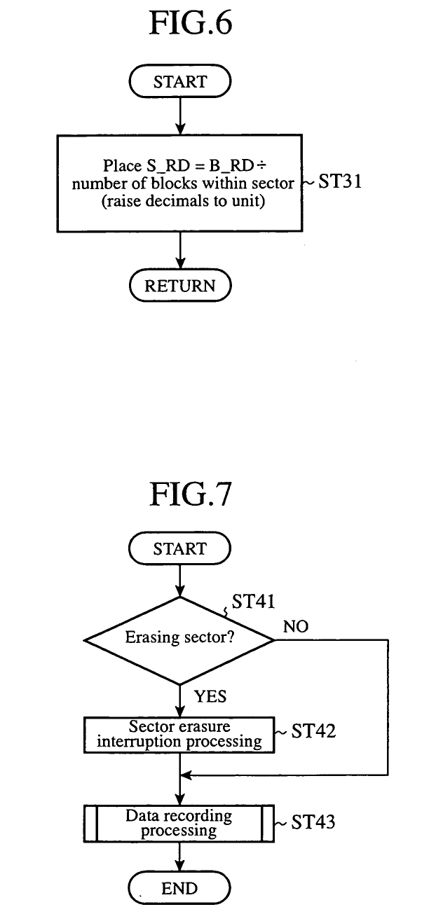

At step ST22, the control section 2 carries out the calculation processing of the number S_RD of the sector 1a that records the latest data. As for the calculation processing, it is performed according to a processing flow (subroutine) provided separately (see FIG. 6 which will be described later).

At step ST23, the control section 2 makes a decision as to whether the latest data read has been completed, and whether no requirement for data recording involving the data recording processing is present. If the requirement is present (No at step ST23) in which case the data erasure cannot be started, the control section 2 returns to step ST23. If the requirement is not present (Yes at step ST23), the control section 2 proceeds to step ST24.

At step ST24, the control section 2 makes a decision as to whether the number S_ER of the sector 1a subjected to the data erasure agrees with the number S_RD of the sector 1a recording the latest data (S_ER=S_RD). If the two numbers agree with each other (Yes at step ST24), which means that the latest data will be lost if the data in the S_ER-th sector 1a is erased, the control section 2 completes the data erasure processing to prevent loss of the latest data. In contrast with this, if the two numbers do not agree (No at step ST24), which means that all the blocks 1b in the S_ER-th sector 1a have already been data recorded, the control section 2 makes a decision that the sector is erasure enabled, and proceeds to state step ST25.

At step ST25, the control section 2 erases the record data of the S_ER-th sector 1a of the flash memory 1 collectively.

At step ST26, the control section 2 updates the number data of the S_ER of the recording erasure position management area 1e to S_ER+1 (S_ER=S_ER-th+1) to advance the number S_ER of the next data erasure target sector 1a by one step.

At step ST27, the control section 2 makes a decision as to whether the “S_ER=S_ER-th+1” updated at step ST26 exceeds the total number of the sectors 1a (four sectors in this case). When it exceeds the total number of the sectors 1a (Yes at step ST27), the control section 2 advances the processing to step ST28, and if it does not exceed the total number of the sectors 1a (No at step ST27), the control section 2 returns the processing to step ST22 to repeat the foregoing processing.

At step ST28, the control section 2 modifies the “S_ER=S_ER-th+1” updated at step ST26 to “S_ER=1” in order to designate the first sector (sector 1a(1)) cyclically, and returns to step ST22.

As described above, the data erasure of the sectors 1a is carried out during idle time in which no data read or write is performed. Thus, it is not necessary to carry out the data erasure at the data recording as in the conventional apparatus, thereby being able to perform the data recording processing in a short time. Accordingly, at the power-down, the data erasure processing is not necessary, but only the recording of the update data is necessary, which makes it possible to carry out the data update processing in a short time.

Assume that the block division number of each sector 1a is N. Then the number of times of erasures becomes (1/N) of that of the conventional examples by erasing the record data of the sector 1a collectively only after all the blocks 1b of the sector 1a have been recorded, thereby being able to prolong the life of the flash memory 1 which has a limit (life) in the number of times of erasures of the data per sector 1a. In addition, since the collective erasure is carried out only after data is recorded in at least one of the blocks 1b of the sector 1a other than the erasure target sector, the latest data can be left without fail.

Next, the calculation processing of the foregoing step ST22 will be described with reference to FIG. 6.

FIG. 6 is a flowchart (subroutine) illustrating the calculation processing of the number S_RD of the sector 1a in which the latest data is recorded. Here, as a precondition of the flowchart, it is assumed that the number of blocks in each sector 1a is fixed (four in this case), and is identical for all the sectors 1a.

In FIG. 6, at step ST31, according to the precondition, the control section 2 can obtain the number S_RD of the sector 1a in which the latest data is recorded by dividing the number B_RD of the block 1b in which the latest data is recorded by the number of blocks in one sector (four, for example). In the division, the decimals are raised to a unit. For example, if the number B_RD of the block 1b that records the latest data is “block 1b(5)” in FIG. 1, “5” of the block 1b(5) is divided by the number of the blocks “4”, and the decimals are raised to a unit, resulting in “2”, that is, the “sector 1a(2)”.

The calculation processing at step ST31 means that it can identify the number S_ER of the erasure target sector 1a after the latest data has been recorded in one of the blocks 1b of the sector 1a. This enables the early identification of the number S_ER of the erasure target sector 1a, and makes the processing easier which carries out the data erasure of the sector 1a in advance during idle time in which no data read or write is performed.

Next, the data recording processing with a function of interrupting the data erasure processing will be described with reference to FIG. 7.

FIG. 7 is a flowchart illustrating the data recording control processing by the control section 2 with the function of interrupting the data erasure processing of the flash memory 1.

In FIG. 7, at step ST41, the control section 2 makes a decision, in response to a data recording request, as to whether the sectors 1a are subjected to the data erasure processing described in connection with FIG. 5. During the data erasure processing (Yes at step ST41), the control section 2 proceeds to step ST42, and not during the data erasure processing (No at step ST41), it proceeds to step ST43.

At step ST42, the control section 2 carries out the interruption processing of the data erasure processing of the sector 1a of the flash memory 1, and proceeds to step ST43.

At step ST43, the control section 2 carries out the data recording processing as described in connection with FIG. 3, and completes the processing.

As described above, when the data recording request is made during the data erasure processing of the sectors 1a, the control section 2 interrupts the data erasure processing and carries out the recording processing of the update data immediately rather than starting the recording processing of the update data after completing the data erasure of the sectors 1a. This enables quick and positive recording of the update data.

As described above, the present embodiment 1 is configured in such a manner that the plurality of sectors 1a constituting the flash memory 1 are each divided into a plurality of blocks 1b; the plurality of blocks 1b are each provided with the data recording area 1c and the block state management area 1d which records the data indicating whether the data is unrecorded, recording or recorded in the data recording area 1c; and the recording erasure position management area 1e, which records the data on the number B_WR of the block in which the data is to be recorded, the data on the number B_RD of the block in which the latest data is recorded and which is the data read target, and the data on the number S_ER of the data erasure target sector 1a, is provided independently of the plurality of sectors 1a, and that the control section 2 controls the flash memory 1 in such a manner that according to the record data of the recording erasure position management area 1e, it records the data cyclically into the data recording areas 1c of the plurality of blocks 1b spreading all over the sectors 1a; reads the record data; collectively erases the record data on a sector by sector basis; and updates the record data of the block state management area 1d and data recording state management area 1e. This enables the control section 2 to make a decision easily as to whether or not the data recorded in the block 1b is reliable according to the “recorded” state the block state management area 1d indicates, or to the “recording” state indicating that the data recording is interrupted before reaching the “recorded” state and hence the incomplete data, thereby being able to improve the accuracy of the data recording.

In addition, the control section 2 restores the record data of the block 1b indicating the “recording” state by utilizing the record data in the “recorded” state in the previous block 1b, and recovers the data close to the latest state, thereby being able to improve the accuracy of the data recording.

Furthermore, the configuration, in which the sectors 1a are each divided into a plurality of blocks 1b, the data are recorded cyclically into the data recording areas of the plurality of blocks 1b spreading all over the sectors 1a, and the erasure of the record data is collectively performed on a sector 1a by sector 1a basis, can prolong the life of the flash memory 1. For example, when each sector 1a is divided into N blocks, the number of times of data rewrites per sector 1a is increased by a factor of N, and the number of times of erasures is reduced to (1/N) as compared with the conventional example. Thus, the life of the flash memory 1, which has a limit (life) in the number of times of data erasures per sector 1a can be lengthened. In addition, since the data are recorded cyclically into the data recording areas of the plurality of blocks 1b, the erasure of the record data is made uniform rather than concentrated to a particular sector as in the conventional example, thereby being able to contribute to extending the life of the flash memory 1, and to improve the reliability.

Moreover, since the collective erasure of the data of the sector 1a is carried out in advance during idle time in which no data read or write is being performed, it is not necessary to erase data at the data recording as in the conventional example. This makes it possible to carry out the data recording processing in a short time. Consequently, the data erasure processing can be obviated at the power-down, and only the recording of the update data is required, which enables the data update processing in a short time.

In addition, since the collective erasure of the data of the sector 1a is carried out only after the data has been recorded in at least one of the blocks 1b of the sector 1a other than the erasure target sector 1a, the latest data can remain without fail.

Furthermore, when a data recording request is made during the data erasure processing of the sector 1a, the recording processing of the update data is carried out immediately after interrupting the data erasure processing rather than after completing the data erasure of the sector 1a. This makes it possible to carry out the recording of the update data quickly and positively.

Moreover, the latest data has a one-to-one correspondence with the block state management area 1d and recording erasure position management area 1e, and they are rewritten at the same time. This makes it possible to circumvent the problem of increasing the number of times of rewritings of a particular area of the flash memory 1.

### Embodiment 2

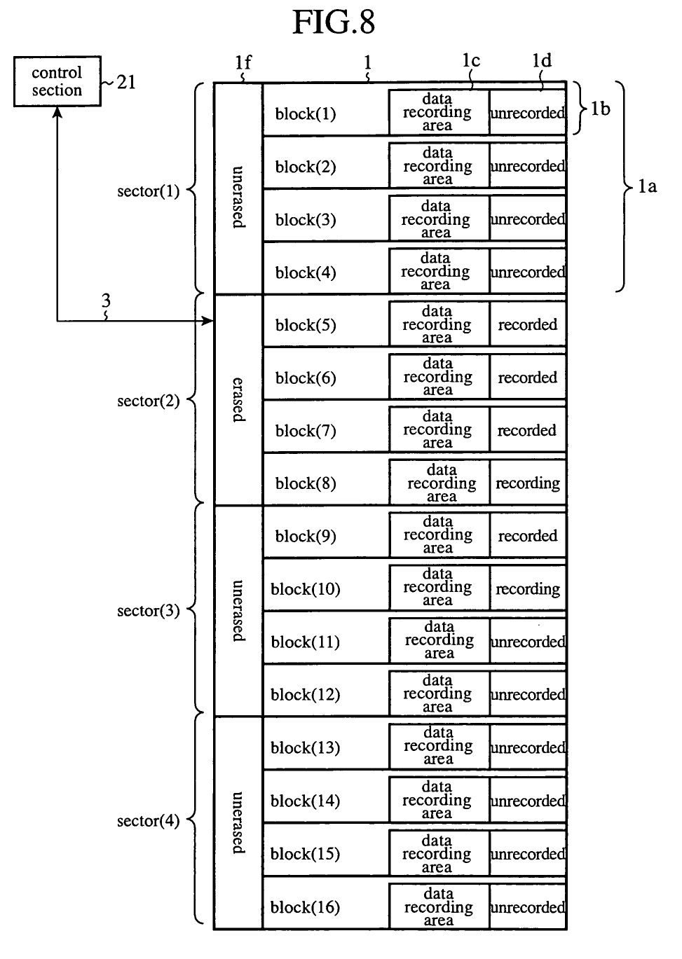

FIG. 8 is a diagram showing a configuration of an information record/read apparatus of an embodiment 2 in accordance with the present invention.

In FIG. 8, the same components as those of FIG. 1 are designated by the same reference numerals. The configuration of the information record/read apparatus of the present embodiment 2 differs from the configuration of FIG. 1 in that instead of the recording erasure position management area 1e of FIG. 1, it has a preceding sector erasure state management area 1f within an area of each sector 1a, and that it has a control section 21 in place of the control section 2. Here, the description of the components with the same reference numerals as those of FIG. 1 will be omitted.

The preceding sector erasure state management area 1f is a region for recording data indicating the data erasure state of the immediately preceding sector 1a. For example, the preceding sector erasure state management area 1f of the sector 1a(2) records the data indicating the data erasure state of the immediately preceding sector 1a (1) FIG. 8 shows an example in which the data in the sector 1a(1) have been erased. The reason for indicating the data erasure state of the immediately preceding sector 1a is to circumvent the problem in that when the data erasure state of the same sector 1a is indicated, the data erasure state of that sector 1a becomes incomplete if the power supply is shut down during the data erasure of that sector 1a.

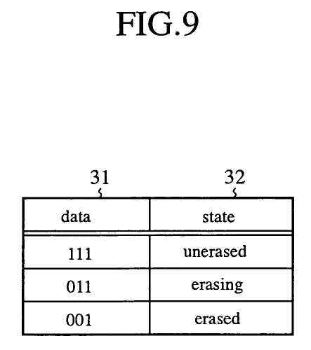

FIG. 9 is a table illustrating data to be recorded in the preceding sector erasure state management area 1f and the states indicated by the data.

In FIG. 9, the reference numeral 31 designates the record data (content) of the preceding sector erasure state management area 1f, and 32 designates the state of the immediately preceding sector 1a of the sector indicated by the record data.

The record data “111” indicates an “unerased” state of the data in the initial state.

The record data “011” indicates an “erasing” state, which means that the data erasure of the immediately preceding sector 1a is started.

The record data “001” indicates an “erased” state, which means that the data erasure of the immediately preceding sector 1a has been completed.

The preceding sector erasure state management areas 1f constitute a data recording state management area for recording the data representing the recording state of the data in all the four sectors 1a from the sector 1a(1) to sector 1a(4).

The control section 21 has the same basic functions as the control section 2 of FIG. 1 except for a partial difference in the control processing method of the flash memory 1. In addition, it is the same as the control section 2 that the control section 21 is composed of a CPU and memory or of a microcomputer.

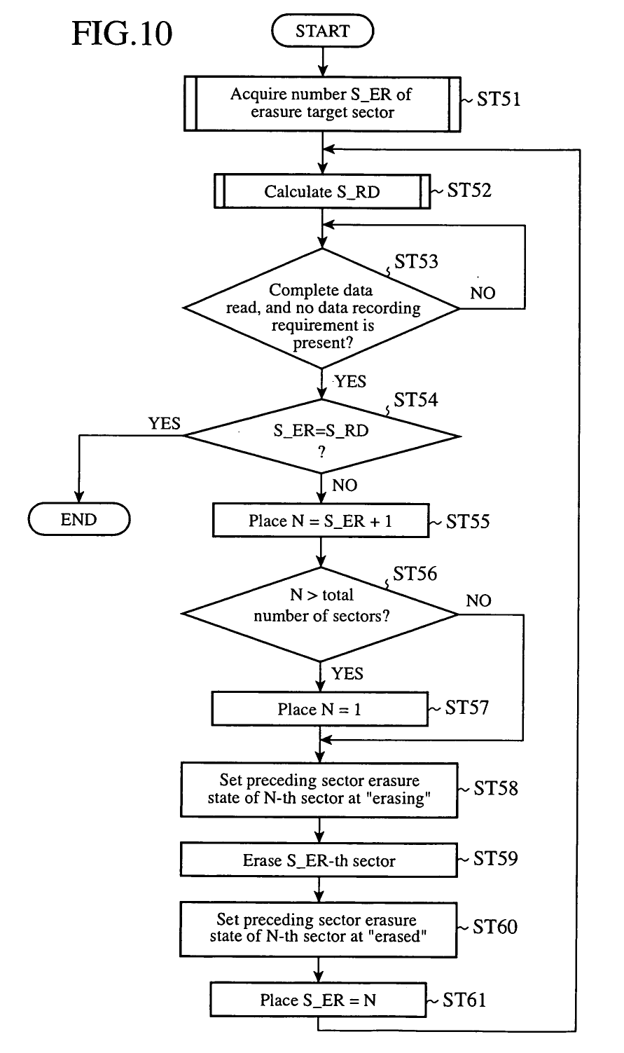

Next, the data erasure processing of the sectors 1a will be described with reference to FIG. 10.

FIG. 10 is a flowchart illustrating the data erasure control processing of the flash memory 1 by the control section 21.

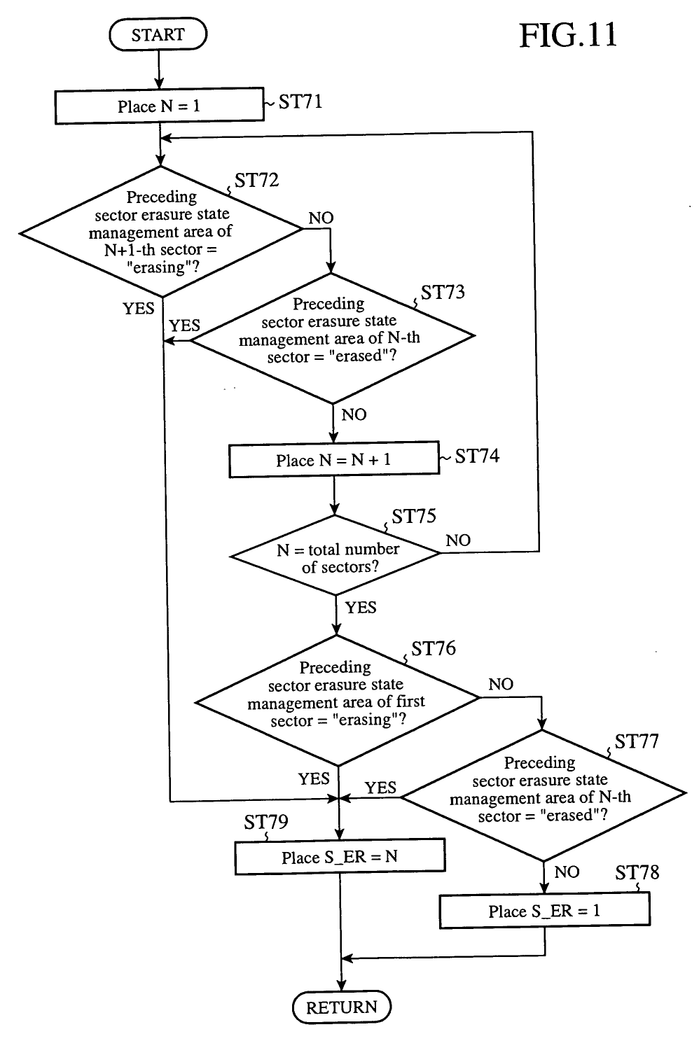

In FIG. 10, at step ST51, the control section 21 acquires the number S_ER of the data erasure target sector 1a by searching the preceding sector erasure state management area 1f of the flash memory 1. The searching processing will be described later (FIG. 11).

As for step ST52, step ST53 and step ST54, since they are the same as steps ST22-ST24 of FIG. 5, their description will be omitted. Only, at step ST52, B_RD (the number of the block 1b recording the latest data) necessary for calculating the number S_RD of the sector 1a recording the latest data (FIG. 6) is obtained by the calculation processing based on the preceding sector erasure state management area 1f.

At step ST55, the control section 21 places a variable N indicating the number of a flag set target sector 1a at “S_ER+1” (N=S_ER+1).

At step ST56, the control section 21 makes a decision as to whether the variable N of the processing at step ST55 exceeds the total number of the sectors 1a (four sectors in the present example). If it exceeds the total number of the sectors 1a (Yes at step ST56), the control section 21 proceeds to step ST57, and if it does not exceed the total number of the sectors 1a (No at step ST56), it proceeds to step ST58.

At step ST57, the control section 21 places the number N at one (N=1).

At step ST58, the control section 21 sets the preceding sector-erasure state management area 1f in the N-th sector 1a at “erasing”.

At step ST59, the control section 21 erases the record data in the S_ER-th sector 1a of the flash memory 1.

At step ST60, after completing the record data erasure of the sector 1a at step ST59, the control section 21 sets the data of the preceding sector erasure state management area 1f of the N-th sector 1a at the “erased” state.

At step ST61, since the sector 1a subjected to the data erasure is the flag set sector 1a at step ST55, the control section 21 sets S_ER at N (S_ER=N) and returns to step ST52.

The foregoing is the data erasure processing of the sector 1a.

Next, the searching processing of the number S_ER of the data erasure target sector 1a will be described with reference to FIG. 11.

FIG. 11 is a flowchart illustrating the retrieving processing of S_ER with checking the state of the preceding sector erasure state management area 1f.

In FIG. 11, at step ST71, the control section 21 sets at one the variable N for storing (representing) the number of the sector 1a whose preceding sector erasure state management area 1f is checked (N=1).

At step ST72, the control section 21 makes a decision as to whether the data in the preceding sector erasure state management area 1f of the N+1-th sector 1a is in the “erasing” state. If it is not in the “erasing” state (No step ST72), the control section proceeds to step ST73, and if it is in the “erasing” state (Yes at step ST72), it proceeds to step ST79.

At step ST73, the control section 21 makes a decision as to whether the preceding sector erasure state management area 1f of the N-th sector 1a is in an “erased” state or not. If it is not in the “erased” state (No at step ST73), the control section 21 proceeds to step ST74, and if it is in the “erased” state (Yes at step ST73), it proceeds to step ST79.

At step ST74, since the sector 1a is not an erasure target, the control section 21 places N at N+1 (N=N+1).

At step ST75, the control section 21 makes a decision as to whether N equals the total number of the sectors 1a. If they do not agree (No at step ST75), the control section 21 returns to step ST72 to continue the retrieving. In contrast with this, if they agree (Yes at step ST75), the control section indicates that the sector 1a is the sector 1a to be processed at last, and proceeds to step ST76.

At step ST76, the control section 21 makes a decision as to whether the preceding sector erasure state management area 1f of the first sector 1a is in the “erasing” state or not. If it is not in the “erasing” state (No at step ST76), the control section 21 proceeds to step ST77, and if it is in the “erasing” state (Yes at step ST76), it proceeds to step ST79.

At step ST77, the control section 21 makes a decision as to whether the preceding sector erasure state management area 1f of the N-th sector 1a is in the “erased” state or not. If it is not in the “erased” state (No at step ST77), the control section 21 proceeds to step ST78, and if it is in the “erased” state (Yes at step ST77), it proceeds to step ST79.

At step ST78, the control section 21 places the number S_ER of the data erasure target sector 1a at one (S_ER=1), and completes the retrieving processing. The processing is carried out because if the preceding sector erasure state management area 1f of the N-th sector 1a is not in the “erased” state at step ST77, this means that none of the sectors 1a has been erased, in which case the number S_ER is placed at one because the first sector becomes the data erasure target sector 1a.

At step ST79, the control section 21 places the number S_ER of the data erasure target sector 1a at N (S_ER=N), and completes the retrieving processing.

The processing at step ST79 is carried out when the decision at step ST72, ST73, ST76 or ST77 is positive.

When the decision at step ST72 is “Yes”, the control section 21 makes a decision that although the erasure processing was carried out in the N-th sector 1a in the past, it was interrupted. Thus, the control section 21 decides that the N-th sector 1a is an erasure target sector 1a, and places S_ER at N.

When the decision at step ST73 is “Yes”, since the immediately preceding sector 1a was erased previously, and the N-th sector 1a is an erasure target sector 1a, S_ER is placed at N.

In addition, when the decision at step ST76 or step ST77 is “Yes”, since the N-th sector 1a is an erasure target sector 1a, S_ER is placed at N.

The foregoing is the retrieving processing of the number S_ER of the data erasure target sector 1a. Once the retrieving processing has been completed, the processing returns to the flow of FIG. 10.

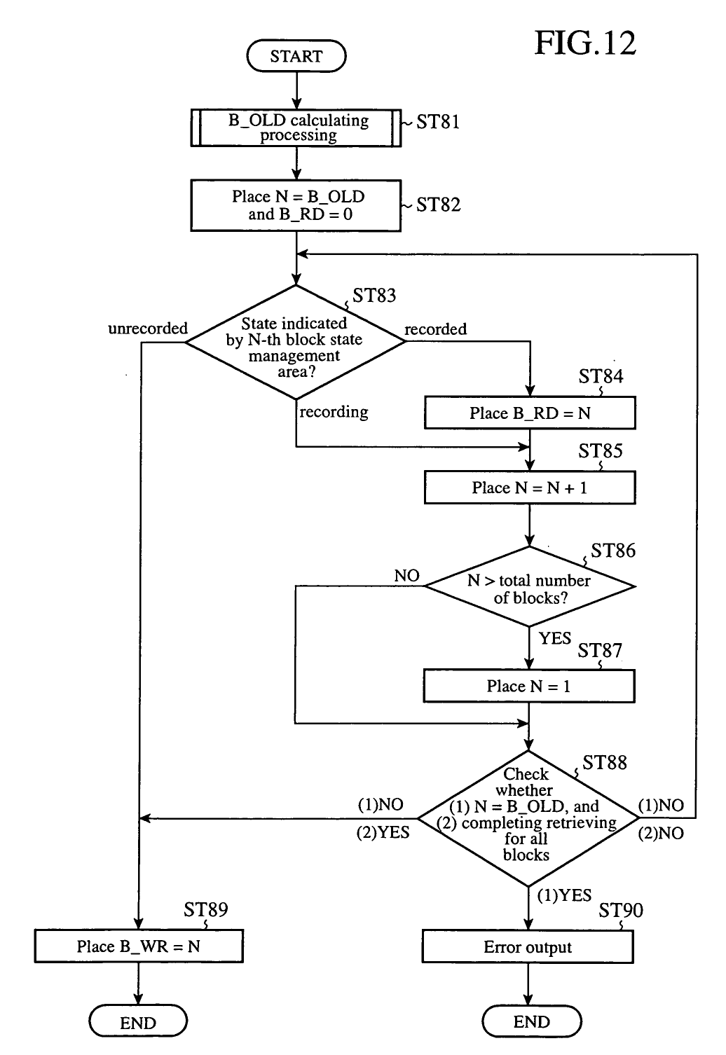

Next, the processing of calculating the data recording target block number (B_WR) and the data read target block number (B_RD) will be described with reference to FIG. 12.

FIG. 12 is a flowchart illustrating the calculation processing of the data write target block number (B_WR) and the data read target block number (B_RD).

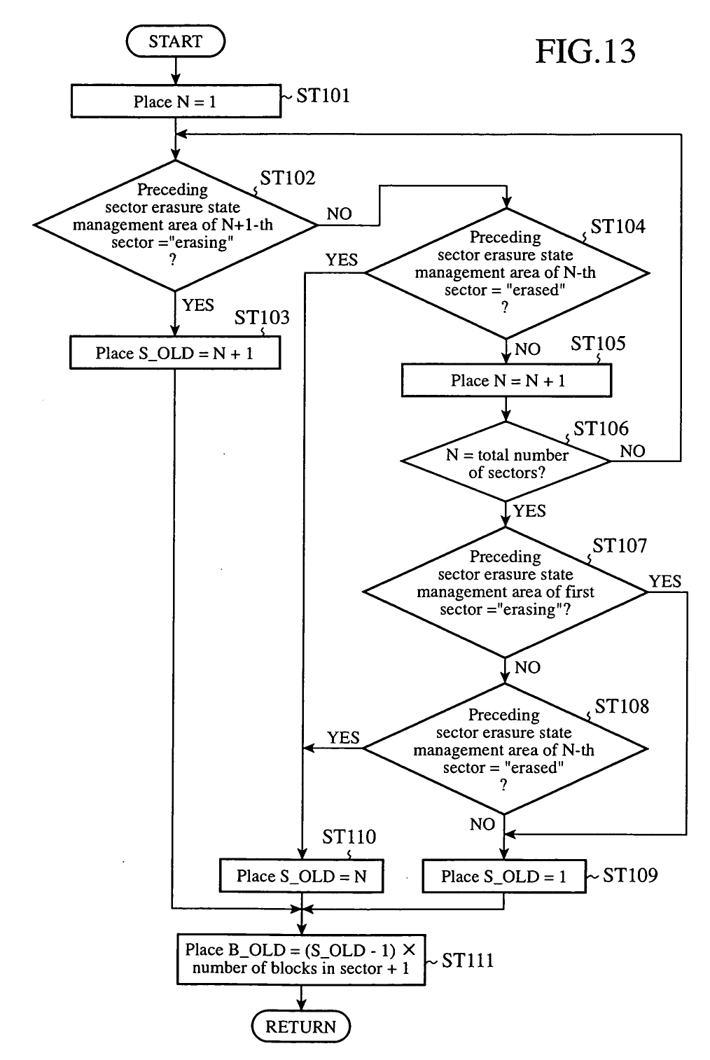

In FIG. 12, at step ST81, the control section 21 calculates the number of the oldest block 1b recorded, B_OLD, which is necessary for calculating the block numbers B_WR and B_RD. The number B_OLD is calculated by a separate processing flow (subroutine). The calculation will be described later (FIG. 13).

At step ST82, the control section 21 places the variable N, which stores the number of the block 1b whose block state management area 1d is checked, at B_OLD (N=B_OLD), and places B_RD at zero (B_RD=0).

At step ST83, the control section 21 makes a decision as to whether the record data of the block state management area 1d of the N-th block 1b is in the “recorded”, “recording” or “unrecorded” state. If it is in the “recorded” state, which means that the N-th block 1b records readable data, the control section proceeds to step ST84. If it is in the “recording” state, which means that the record data is not normal data, the control section 21 proceeds to step ST85. If it is in the “unrecorded” state, which means that the N-th block 1b is in a data writable state, the control section 21 proceeds to step ST89.

At step ST84, the control section 21 places B_RD at N (B_RD=N) and proceeds to step ST85. If the processing occurs of returning from step ST88 which will be described later to step ST83, the control section 21 places the number B_RD at the number of the block 1b in the “recorded” state finally checked.

At step ST85, the control section 21 places N at N+1 (N=N+1) to check the block state management area 1d of the next block 1b.

At step ST86, the control section 21 makes a decision as to whether the number N set at step ST85 exceeds the total number of the blocks (16 blocks in the present example). If N exceeds the total number (Yes at step ST86), the control section 21 proceeds to step ST87, and unless N exceeds the total number (No at step ST86), it proceeds to step ST88.

At step ST87, the control section 21 places N at one (N 1).

At step ST88, the control section 21 makes a decision as to whether N equals B_OLD (N=B_OLD), and whether the retrieving as to the processing from step ST83 to step ST87 has been completed for all the blocks 1b. If N is unequal to B_OLD (N≠B_OLD), and the retrieving as to all the blocks 1b has not yet been completed, the control section 21 returns to step ST83 to continue the processing. If N is unequal to B_OLD (N≠B_OLD), and the retrieving as to all the blocks 1b has been completed, the control section 21 proceeds to step ST89. If N is equal to B_OLD (N=B_OLD), the control section 21 proceeds to step ST90 regardless of whether the retrieving as to all the blocks 1b has been completed or not.

At step ST89, the control section 21 places B_WR at N (B_WR N), and completes the calculation processing. The processing is carried out because the number of the recording target block 1b is stored in N at the time when the processing reaches step ST89 from step ST83 or step ST88.

At step ST90, the control section 21 carries out an error output, and completes the calculation processing. The processing is carried out because if N is equal to B_OLD (N=B_OLD), which means that all the blocks 1b have been recorded, no record target block is present, and hence the error is output, followed by the end of the calculation processing.

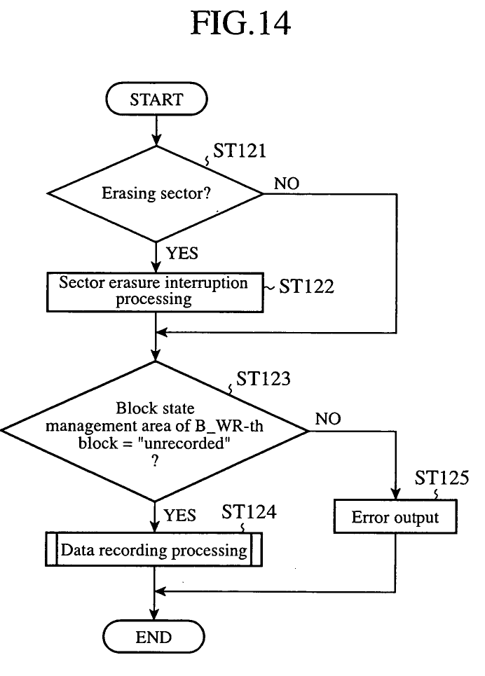

The foregoing is the calculation processing of the data write target block number (B_WR) and data read target block number (B_RD). According to the number B_WR obtained by the calculation processing, the data write processing is carried out, and according to the number B_RD, the data read processing is carried out. As for the data read processing, it follows the flowchart of FIG. 4 described before. As for the data recording processing, it will be described later (FIG. 14).

Next, the processing at step ST81 in the flowchart of FIG. 12 (calculation processing of B_OLD) will be described with reference to FIG. 13.

FIG. 13 is a flowchart (subroutine) illustrating the calculation processing of the number of the oldest recorded block 1b, B_OLD, according to the state of the preceding sector erasure state management area 1f.

To obtain the number B_OLD, the control section 21 obtains the number S_OLD of the sector 1a that records the oldest data, and then calculates B_OLD.

In FIG. 13, at step ST101, the control section 21 places at one the variable N that stores the number of the sector 1a with which the preceding sector erasure state management area 1f is checked (N=1).

At step ST102, the control section 21 makes a decision as to whether the preceding sector erasure state management area 1f of the N+1-th sector 1a is in an “erasing” state or not. If it is in the “erasing” state (Yes at step ST102), the control section 21 proceeds to step ST103, and if it is not in the “erasing” state (No at step ST102), it proceeds to step ST104.

At step ST103, the control section 21 places S_OLD at N+1 (S_OLD=N+1), and proceeds to step ST111. The processing is carried out because a decision is made that the data in this sector 1a is interrupted during the erasing.

At step ST104, the control section 21 makes a decision as to whether the preceding sector erasure state management area 1f of the N-th sector 1a is in the “erased” state or not. If it is not in the “erased” state (No at step ST104), the control section 21 proceeds to step ST105, and if it is in the “erased” state (Yes at step ST104), it proceeds to step ST110.

At step ST105, the control section 21 places N at N+1 (N=N+1) to check the next sector 1a.

At step ST106, the control section 21 makes a decision as to whether N equals to the total number of the sector 1a. If they do not agree (No at step ST106), the control section returns to step ST102 to continue the check, and if they agree (Yes at step ST106), it proceeds to step ST107 considering that the N-th sector 1a is the sector 1a to be processed finally.

At step ST107, the control section 21 makes a decision as to whether the preceding sector erasure state management area if of the first sector 1a is in the “erasing” state or not. If it is not in the “erasing” state (No at step ST107), the control section 21 proceeds to step ST108, and if it is in the “erasing” state (Yes at step ST107), it proceeds to step ST109.

At step ST108, the control section 21 makes a decision as to whether the preceding sector erasure state management area 1f of the N-th sector 1a is in the “erased” state or not. If it is not in the “erased” state (No at step ST108), the control section 21 proceeds to step ST109, and if it is in the “erased” state (Yes at step ST108), it proceeds to step ST110.

At step ST109, the control section 21 places S_OLD at one (S_OLD=1), and proceeds to step ST111. The processing is carried out because the decision of “erasing” at step ST107 (Yes at step ST107), and the decision of not “erased” at step ST108 (No at step ST108) indicate that none of the sectors is erased, and hence the oldest sector is 1.

At step ST110, the control section 21 places S_OLD at N, and proceeds to step ST111. The processing is carried out because when the decision at step ST104 or step ST108 is “erased” (Yes at step ST104 or ST108), the data in this sector 1a is the oldest.

At step ST111, since the control section 21 determines the number S_OLD up to this step ST111, it calculates the number B_OLD of the oldest recorded block 1b from the number S_OLD using the following expression, and completes the calculation processing.

B_OLD=(S_OLD−1)×number of blocks in sector 1a+1

Thus, the control section 21 determines the number B_OLD necessary for calculating B_WR and B_RD, and returns to the flow of FIG. 12.

Next, the data recording processing with a function of interrupting the data erasure processing will be described with reference to FIG. 14.

FIG. 14 is a flowchart illustrating the data recording control processing with the function of interrupting the data erasure of the flash memory 1 by the control section 21.

In FIG. 14, at step ST121, the control section 21 makes a decision as to whether the data erasure of the sector 1a described in connection with FIG. 10 is going on at the time when the data recording request is made. If the data erasure is going on (Yes at step ST121), the control section 21 proceeds to step ST122, and if the data erasure is not being carried out (No at step ST121), it proceeds to step ST123.

At step ST122, the control section 21 interrupts the data erasure of the sector 1a of the flash memory 1, and proceeds to step ST123.

At step ST123, the control section 21 checks whether the block state management area 1d of the B_WR-th block in which data is to be written is in the “unrecorded” state. If it is in the “unrecorded” state (Yes at step ST123), the control section 21 proceeds to step ST124, and if it is not in the “unrecorded” state (No at step ST123), it proceeds to step ST125.

At step ST124, since the erasure of the sector 1a has been completed, and the data recording into the B_WR-th block 1b becomes possible, the control section 21 carries out the data recording as described in FIG. 3, and terminates the processing.

At step ST125, since the content of the block state management area 1d disagrees with the state of the block 1b, the control section 21 outputs an error, and terminates the data recording processing.

As described above, the present embodiment 2 is configured in such a manner that the flash memory 1 has the preceding sector erasure state management area 1f within the area of each sector 1a instead of the recording erasure position management area 1e of the embodiment 1 (FIG. 1); and the preceding sector erasure state management area 1f records the data indicating the data erasure state of the immediately preceding sector 1a, and that the control section 21 retrieves the number S_ER of the data erasure target sector 1a according to the preceding sector erasure state management area 1f; calculates, according to the block state management area 1d and the preceding sector erasure state management area 1f, the number B_WR of the block 1b for recording the data and the number B_RD of the block 1b which records the latest data and becomes the data read target; records data cyclically to the data recording areas 1c of the plurality of blocks 1b spreading all over the sectors 1a according to the retrieved or calculated S_ER, B_WR and B_RD; and controls the flash memory 1 to read the record data, to collectively erase the record data, and to update the record data in the block state management area 1d and preceding sector erasure state management area 1f. As a result, the numbers S_ER, B_WR and B_RD can be determined even if the power supply is shut down without providing the recording erasure position management area 1e of the embodiment 1, which records the data about S_ER, B_WR and B_RD.

In addition, even if the data erasure of the sector 1a is interrupted, the S_ER can be identified without fail (FIG. 11). Besides, even if the recording is interrupted, it is possible to read the latest normal data without reading the incomplete data (FIG. 12).

Furthermore, the latest data has the one-to-one correspondence with the block state management area 1d and preceding sector erasure state management area 1f, and they are rewritten at the same time. Thus, the problem is avoidable of increasing the number of times of rewritings of only a particular area of the flash memory 1.

Moreover, the same advantages as those of the embodiment 1 can be achieved.

According to the “recorded” and “recording” data indicated by the block state management area 1d, the reliability of the record data can be easily decided, and hence the accuracy of the data recording can be improved.

The life of the flash memory 1 can be extended because the number of times of erasures is reduced by a factor of N (N is the number of blocks per sector) as compared with the conventional system, and the erasures are made even without concentrating to a particular sector 1a as in the conventional system.

The data recording can be completed in a short time because the collective erasure of the data of the sectors 1a is carried out using idle time during which the read and write of the data are not performed.

The latest data can be left without fail because the collective erasure of the data of the sectors 1a is carried out only after the data is recorded to one of the blocks 1b of the next sector 1a.

The recording of the update data is carried out quickly and positively even if a data recording request is made during the erasure of the sector 1a, because the data erasure is interrupted, and the recording of the update data is performed immediately.

### INDUSTRIAL APPLICABILITY

As described above, the information record/read apparatus in accordance with the present invention is suitable for recording, reading and erasing data of the involatile memory.

What is claimed is:

1. An information record/read apparatus comprising:
an involatile memory including a plurality of sectors which constitute part of a data recording area and are a data erasure unit, a plurality of blocks which are formed by dividing each of the plurality of sectors and each have a data recording area and a block state management area for recording data indicating as to whether data is in an unrecorded, recording or recorded state in the data recording area, and a data recording state management area for recording data indicating recording states of the data in all the plurality of sectors; and
a control section for controlling, according to the record data in the data recording state management area of said involatile memory or to the record data in the block state management area and in the data recording state management area, said involatile memory in a manner that writes data cyclically into the data recording areas of the plurality of blocks of all the sectors, reads the record data, collectively erases the record data on a sector by sector basis, and updates the record data in the block state management area and data recording state management area in accordance with write, read or erasure of the data.

2. The information record/read apparatus according to claim 1, wherein the data recording state management area, which is provided independently of the plurality of sectors, records data on numbers of blocks that record data, data on the number of a block that records latest data, and data on the number of a data erasure target sector, and wherein said control section acquires from the data recording state management area the data on the numbers of the blocks that record the data, the data on the number of the block that records the latest data, or the data on the number of the data erasure target sector, and carries out writing, reading and erasing data in accordance with the acquired data.

3. The information record/read apparatus according to claim 1, wherein the data recording state management area, which is provided within an area of each of the plurality of sectors, records data indicating a data erasure state of an immediately preceding sector, wherein said control section calculates data on numbers of blocks that record data and the number of a block that records latest data from the data recording state management area and block state management area, or retrieves data on the number of a data erasure target sector from the data recording state management area, and wherein said control section carries out writing, reading and erasing of data in accordance with the data calculated or retrieved.

4. The information record/read apparatus according to claim 1, wherein said control section controls said involatile memory in a manner that erases the record data during a period of time from the data read to data write.

5. The information record/read apparatus according to claim 1, wherein said control section controls said involatile memory in a manner that collectively erases data recorded in individual blocks of an erasure target sector after writing data in at least one of the blocks of a sector other than the erasure target sector.

6. The information record/read apparatus according to claim 5, wherein to carry out data recording during collective erasure of the record data in the erasure target sector, said control section controls said involatile memory in a manner that gives priority to data recording processing by interrupting the collective erasure.
